(19) United States
(12) Patent Application Publication
(10) Pub. No.: US 2026/0218495 A1
(43) Pub. Date: Jul. 30, 2026

(54) VEHICLE POSTURE MEASUREMENT USING ULTRA-WIDEBAND POSITION TRACKING

(71) Applicant: Deere & Company, Moline, IL (US)

(72) Inventors: Mark Sorial, Dubuque, IA (US); Giovanni A. Wuisan, Epworth, IA (US); Tianshuang Gao, Peosta, IA (US); Scott J. Breiner, Dubuque, IA (US)

(21) Appl. No.: 19/041,158

(22) Filed: Jan. 30, 2025

(51) Int. Cl. E02F 9/26; E02F 3/34; E02F 3/43; E02F 9/08; G01S 13/02; G01S 13/76

(52) U.S. Cl. CPC E02F 9/264; E02F 3/431; E02F 9/0841; G01S 13/0209; G01S 13/765; E02F 3/34

(57) ABSTRACT

A work machine includes a system of at least one tag device and multiple anchor devices. The tag device is positioned on a portion of the work machine that moves with respect to a base portion of the work machine. The anchor devices are positioned in respective known, fixed locations in a coordinate system of the base portion of the work machine. The tag device polls the anchor devices and receives responses from the anchor devices. The respective time duration from polling one of the anchor devices to receiving a response from the anchor device is used to calculate a respective distance between the tag device and the anchor device. The respective calculated distances and the known locations of the anchor devices are used to determine the location of the tag device in the coordinate system of the work machine.

### FIELD OF THE DISCLOSURE

This disclosure relates to a system and method for determining the location of a movable element of an off-highway machine using ultra-wideband position tracking.

### BACKGROUND

Off-highway machines are used to modify terrain and to move materials at construction sites and the like. Off-highway machines are also used in agriculture to prepare fields, plant and maintain crops, harvest and transport crops, and the like. The machines generally have large wheels or tracks as terrain engagement members to enable the machines to move on uneven terrain. The machines serve as mobile support platforms for hydraulically powered implements attached to the machines. The attached implements manipulate materials. For example, certain implements engage soil or other materials and move the soil or other materials to other locations. The attached implements may push or pull the materials to different locations on the terrain using a blade such as a blade on a dozer or grader. The attached implements may remove the material from the terrain using a bucket or other similar implement and carry the material to a new location, either directly or by transferring the material to a transport vehicle such as a truck. Other types of implements include grinders that transform bulk material (e.g., trees, used concrete or pavement, or the like) into smaller sized material.

Many tasks of an off-highway machine can be automated or semiautomated. For example, the movements of the machine about a worksite, including the location and orientation of the machine can be controlled by an onboard computer or by a central computer at the worksite. In addition, the movements of movable elements of a machine can also be controlled automatically. For example, movable elements can include a boom arm, a work implement with an engagement edge, a dozer blade, or an articulated portion of the machine.

To be able to control the movement of a movable element to a desired position requires knowledge of the position of the movable element with respect to the machine. Previous systems for determining the position of a movable have utilized sensors on either side of joints between elements to determine joint angles. The joint angles and knowledge of the lengths of the elements between joints allow the position of an element to be calculated using trigonometric relationships. In some cases, to determine the position of a specific movable element can require multiple joint angles and multiple element lengths such that any measurement or calculation errors add up to cause a stacking error.

### SUMMARY

In view of the foregoing, a need exists for a system and method that enables direct measurement of the location of a movable element with respect to the machine.

One aspect of the embodiments disclosed herein is a work machine that includes a system of at least one tag device and multiple anchor devices. The tag device is positioned on a portion of the work machine that moves with respect to a base portion of the work machine. The anchor devices are positioned in respective known, fixed locations in a coordinate system of the base portion of the work machine. The tag device polls the anchor devices and receives responses from the anchor devices. The respective time duration from polling one of the anchor devices to receiving a response from the anchor device is used to calculate a respective distance between the tag device and the anchor device. The respective calculated distances and the known locations of the anchor devices are used to determine the location of the tag device in the coordinate system of the work machine.

Another aspect of the embodiments disclosed herein is a method of determining a coordinate position of a movable device, which moves with respect to a work vehicle coordinate system of a work vehicle. The method determines a first variable distance of the movable device from a first fixed device positioned at a first fixed set of coordinates in the work vehicle coordinate system by sending a first polling signal from the movable device to the first fixed device, receiving a first response signal from the first fixed device, and determining a first propagation time between sending the first polling signal and receiving the first response signal. The method determines a second variable distance of the movable device from a second fixed device positioned at a second fixed set of coordinates in the work vehicle coordinate system by sending a second polling signal from the movable device to the second fixed device, receiving a second response signal from the second fixed device, and determining a second propagation time between sending the second polling signal and receiving the second response signal. The method determines a third variable distance of the movable device from a third fixed device positioned at a third fixed set of coordinates in the work vehicle coordinate system by sending a third polling signal from the movable device to the third fixed device, receiving a third response signal from the third fixed device, and determining a third propagation time between sending the third polling signal and receiving the third response signal. The method determines a fourth variable distance of the movable device from a fourth fixed device positioned at a fourth fixed set of coordinates in the work vehicle coordinate system by sending a fourth polling signal from the movable device to the fourth fixed device, receiving a fourth response signal from the fourth fixed device, and determining a fourth propagation time between sending the fourth polling signal and receiving the fourth response signal. The method calculates a coordinate position of the movable device in the work vehicle coordinate system based on the first, second, third, and fourth sets of coordinates and the first, second, third, and fourth variable distances.

In certain embodiments in accordance with this aspect, the method determines each of the first, second, third, and fourth propagation times by measuring a respective time duration from sending the respective polling signal from the movable device to the respective fixed device to receiving the respective response signal from the respective fixed device; by subtracting a respective known delay time within the respective fixed device from the respective time duration to obtain a respective two-way propagation time; and by dividing the respective two-way propagation time by two to generate the respective propagation time. In certain embodiments, the respective internal time delays of the respective fixed devices are substantially equal.

In certain embodiments in accordance with this aspect, the first, second, third, and fourth polling signals and the first, second, third, and fourth response signals are ultra-wideband (UWB) signals operating in a range of 3.1 GHz to 10.6 GHz.

In certain embodiments in accordance with this aspect, the method further includes sending the calculated coordinate location of the movable device to a processing system. The processing system combines the coordinate location of the movable device in the vehicle coordinate system with a coordinate location of the work vehicle in a primary coordinate system to produce a coordinate location of the movable device in the primary coordinate system.

In certain embodiments in accordance with this aspect, the work machine is a loader. The movable device is positioned on the boom arm of the loader. The fixed devices are positioned on a body of the loader. In certain embodiments, a second movable device is positioned on a work implement pivotally attached to the boom arm of the loader. The second movable device determines respective first, second, third, and fourth variable distances to the respective first, second, third, and fourth fixed devices. The second movable device calculates a position of the second movable device in the work vehicle coordinate system.

In certain embodiments in accordance with this aspect, the work machine is an articulated loader having a rear body section and an articulated front body section. The front body section pivots with respect to the rear body section. The movable device is positioned on the front body section of the articulated loader. The fixed devices are positioned on the rear body section of the articulated loader. The movable device calculates a position of the movable device in a coordinate system of the rear body section. The position of the movable device in the coordinate system of the rear body section is used to calculate an articulation angle of the front body section with respect to the rear body section.

Another aspect of the embodiments disclosed herein is method of determining a location of a movable element of a work vehicle with respect to a worksite coordinate system. The method determines a location and orientation of the work vehicle with respect to the worksite coordinate system. The method positions first, second, and third communication devices at respective first, second, and third known locations in a work vehicle coordinate system. The method positions a fourth communication device on the movable element of the work vehicle. The fourth communication device is positioned at an unknown variable location in the work vehicle coordinate system. The method sends respective first, second, and third polling signals from the fourth communication device to the first, second, and third communication devices. The method receives respective first, second, and third response signals by the fourth communication device from the respective first, second, and third communication devices. The method determines respective first, second, and third variable distances from the fourth communication device to the respective first, second, and third communication devices based on respective calculated propagation times between the fourth communication device and the respective first, second, and third communication devices. The method calculates a location of the fourth communication device in the work vehicle coordinate system based on the first, second, and third known locations, respectively, of the first, second, and third communication devices, and the first, second, and third variable distances. The method combines the location of the fourth communication device in the work vehicle coordinate system with the location and orientation of the work vehicle in the worksite coordinate system to determine the location of the fourth communication device in the worksite coordinate system.

Another aspect of the embodiments disclosed herein is a work vehicle. The work vehicle comprises a front body section and a rear body section. The rear body section houses a power generation system. The front and rear body sections support ground engagement units that move the work vehicle with respect to the terrain of a worksite in response to power provided by the power generation system. At least one working element of the work vehicle is movably coupled to a portion of the work vehicle. At least first, second, third, and fourth communication devices are positioned at respective first, second, third, and fourth known locations in a work vehicle coordinate system. At least a fifth communication device positioned on the at least one working element. The fifth communication device is configured to poll each of the first, second, third, and fourth communication devices; receive a respective response from each of the first, second, third, and fourth communication devices; and determine a respective first, second, third, and fourth variable distance from the fifth communication device to each of the respective first, second, third, and fourth communication devices. The fifth communication device is further configured to calculate a variable location of the fifth communication device in the work vehicle coordinate system based on the first, second, third, and fourth known locations and the first, second, third, and fourth variable distances. The fifth communication device is further configured to output data representing the variable location of the fifth communication device in the work vehicle coordinate system. The work vehicle further includes at least one vehicle positioning system configured to determine a location and orientation of the work vehicle in a worksite coordinate system. The vehicle positioning system is further configured to receive the data representing the variable location of the fifth communication device and to determine the location of the working element in the worksite coordinate system.

In certain embodiments in accordance with this aspect, the working element is a boom arm pivotally coupled to the front body section of the work vehicle, and the fifth communication device is located on the boom arm.

In certain embodiments in accordance with this aspect, the working element is a work implement pivotally coupled to a boom arm of the work vehicle, and the fifth communication device is located on the work implement.

In certain embodiments in accordance with this aspect, the working element is the front body section of the work vehicle, which is articulately coupled to the rear body section of the work vehicle. The fifth communication device is located on the front body section, and the first, second, third, and fourth communication devices are located on the rear body section of the work vehicle.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 illustrates an elevational side view of an exemplary articulated off-highway machine into which the improvements disclosed herein may be incorporated, the illustrated off-highway machine including a boom that supports a work implement, the off-highway machine including tag devices and anchor devices for determining the positions of the boom and the work implement.

FIG. 2 illustrates an elevational side view of the off-highway machine of FIG. 2 with the boom raised to elevate the work implement.

FIG. 3 illustrates a top plan view of the off-highway machine of FIG. 1 with the front portion of the machine aligned with the rear (main) portion of the machine for non-turning movement of the machine, the front portion and the rear portion of the machine including tag devices and anchor devices for determining the orientation of the front portion with respect to the rear portion.

FIG. 4 illustrates the off-highway machine of FIG. 1 with the front portion of the machine positioned at an angle with respect to the rear (main) portion of the machine to enable turning movement of the machine.

FIG. 5 is a timing diagram that illustrates total time from a tag device transmitting a polling signal, an anchor device receiving the polling signal and transmitting a response signal after an internal delay, and the tag device receiving the response signal.

FIG. 6 illustrates a schematic diagram representing a tag device and four anchor devices in a three-dimensional coordinate system.

FIG. 7 illustrates a schematic block diagram of first and second systems of tags and anchors in communication with a location processing system.

FIG. 8 illustrates a flowchart of a method for determining the position of a tag in a three-dimensional coordinate system having four fixed anchors.

### DETAILED DESCRIPTION

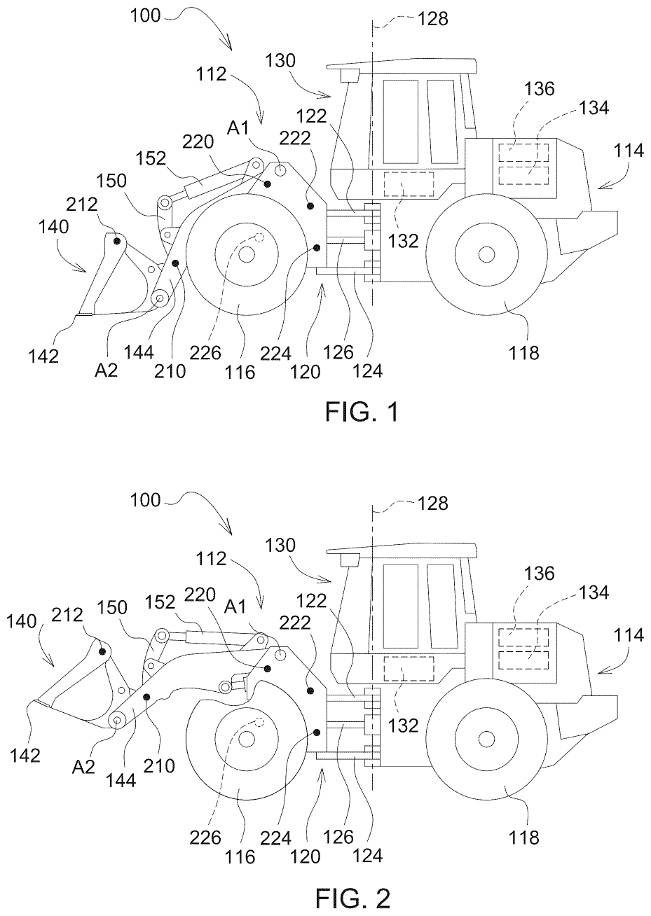

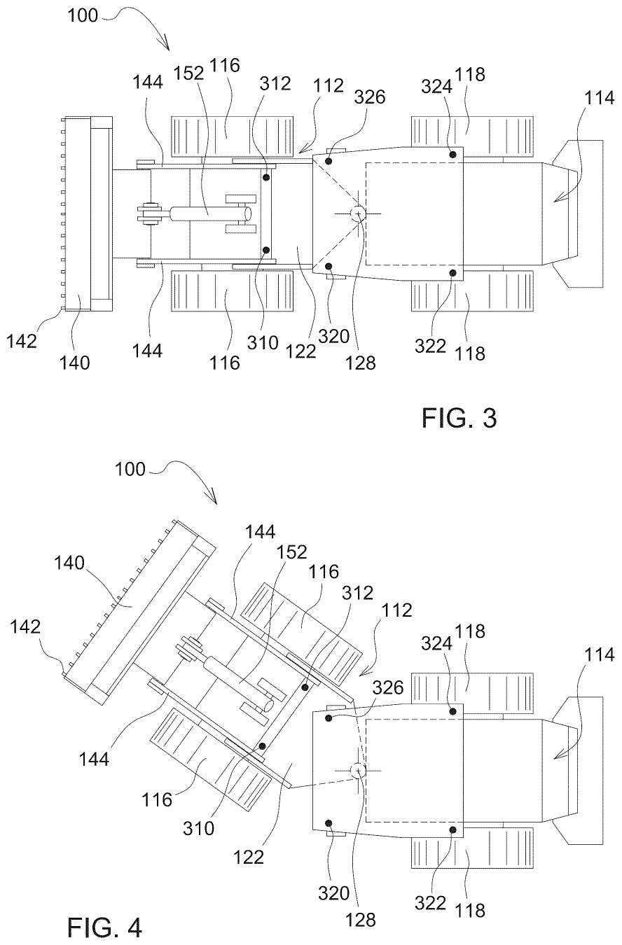

FIGS. 1 and 2 illustrate left side elevational views of an exemplary off-highway machine 100 into which the improvements disclosed herein may be incorporated. The right side views of the machine are generally the mirror images of the left side views and are not illustrated separately. FIGS. 3 and 4 illustrate top plan views of the machine of FIG. 1. The illustrated off-highway machine is embodied as a front-end loader (hereinafter “loader”); however, the improvements may also be incorporated into other types of off-highway machines such as dozers, graders, excavators, earthmovers, agricultural machines, and the like. In general, such off-highway machines have large wheels or tracks operating as terrain-engagement members to enable the machines to move on uneven surfaces. The off-highway machines provide a movable platform for material handling implements such as dozer blades, grader blades, loader buckets, excavator buckets that engage material such as dirt, gravel, rocks, trees, and the like, and move the material from a first location to a second location.

The loader 100 of FIGS. 1 and 2 includes a front body section 112 with a front frame and a rear body section 114 with a rear frame. The front body section is articulated with respect to the rear body section. The front body section includes a set of front wheels 116 with a respective one of the front wheels on each side of the front body section. The rear body section includes a set of rear wheels 118 with a respective one of the rear wheels on each side of the rear body section. The wheels may be referred to herein as terrain-engagement members. Only the respective left front tire and left rear tire are shown in FIGS. 1 and 2. Different embodiments can include different terrain-engagement members, such as treads or tracks.

The front body section 112 and the rear body section 114 of the loader 100 are connected to each other by an articulation connection 120 so the front and rear body sections can pivot in relation to each other about a vertical axis 128. The vertical axis is orthogonal to the direction of travel and orthogonal to rotational axes of the wheel axis. The articulation connection includes at least one upper connection plate 122, at least one lower connection plate 124, and at least a pair of articulation cylinders 126 (only one shown in FIGS. 1 and 2). A respective one of the articulation cylinders is positioned on each side of the loader. Pivoting movement of the front body section with respect to the rear body section is achieved by selectively varying hydraulic fluid flow applied to the articulation cylinders to selectively extend and retract the piston rods in the articulation cylinders in a well-known manner such that the front body portion pivots with respect to the rear body portion with respect to the vertical pivot axis, which is represented as a dot in FIGS. 3 and 4.

The rear body section 114 of the loader 100 includes an operator cab 130 in which the operator controls the loader. A user interface 132 is positioned in the cab. The user interface can include different combinations of a steering wheel, control levers, joysticks, control pedals, and control buttons. The operator can actuate one or more controls of the user interface to control movement of the loader front-end loader and the different loader components. The rear body section 114 of the loader also houses a prime mover 134 and a control system 136. The prime mover can comprise an internal combustion engine (ICE), such as a diesel engine. The control system can comprise a vehicle control unit (VCU).

A work implement 140 having an engagement edge 142 is movably connected to the front body section 112 of the loader 100 by at least one boom arm 144. The work implement is used to handle and/or move objects or material such as soil, rocks, debris, or the like. In the illustrated embodiment, the work implement is depicted as a bucket, although other implements, such as a fork assembly, can also be used. Only a single boom arm is shown in the side view of FIG. 1; however, in the illustrated embodiment, a second boom arm (not shown) is positioned in a like location on the opposite side of the front body section. The illustrated boom arm is pivotably connected to the frame of the front body section about a first pivot axis A1, and the illustrated work implement is pivotably connected to the boom arm about a second pivot axis A2. The second boom arm is pivotably connected to the frame of the front body section and to the work implement about corresponding pivot axes on the opposite side of the front body section. Unless otherwise stated, references to the boom arm in the following description apply to both boom arms. The work implement and the boom arm illustrated in lowered positions in FIG. 1 and are illustrated in raised positions in FIG. 2.

As shown in FIG. 2, at least one boom hydraulic cylinder 146 is mounted to the frame of the front body section 112 and is connected to the boom arm 144. Although only one hydraulic cylinder is shown in the side view of FIG. 2, the illustrated embodiment includes at least a second hydraulic cylinder (not shown) with the second cylinder positioned on the opposite side and connected to the second boom arm (not shown). In other embodiments, the loader 100 may have additional boom hydraulic cylinders. The boom hydraulic cylinders can be extended or retracted to raise or lower the boom arm and thus adjust the vertical position of the engagement edge 142 of the work implement 140 relative to the front body section 112.

As shown in FIGS. 1 and 2, at least one pivot linkage 150 is connected to the work implement 140 and to the boom arm 144. At least one pivot hydraulic cylinder 152 is mounted between the first boom arm and the second boom arm (not shown). The loader may have additional pivot hydraulic cylinders to provide additional force for pivoting the work implement. The pivot hydraulic cylinder can be extended or retracted to pivot the work implement about the second pivot axis A2. In some embodiments, the work implement may be moved in different manners (e.g., around additional pivot axes) and a different number or configuration of hydraulic cylinders or other actuators may be used.

As described above the front body section 112 is articulated with respect to the rear body section 114 of the loader 100. FIG. 3 illustrates the front body section aligned with the rear body section for movement of the loader in a generally straight line. FIG. 4 illustrates the front body section pivoted with respect to the rear body section to cause the loader to turn. The front body section pivots with respect to the vertical pivot axis 128 in response to the operation of the pair of articulation cylinders 126 (one shown in FIGS. 1 and 2).

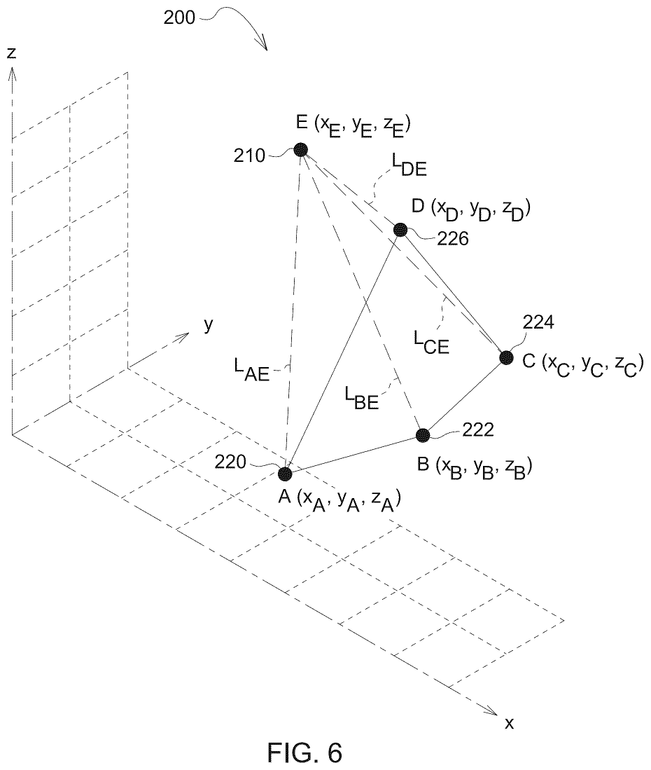

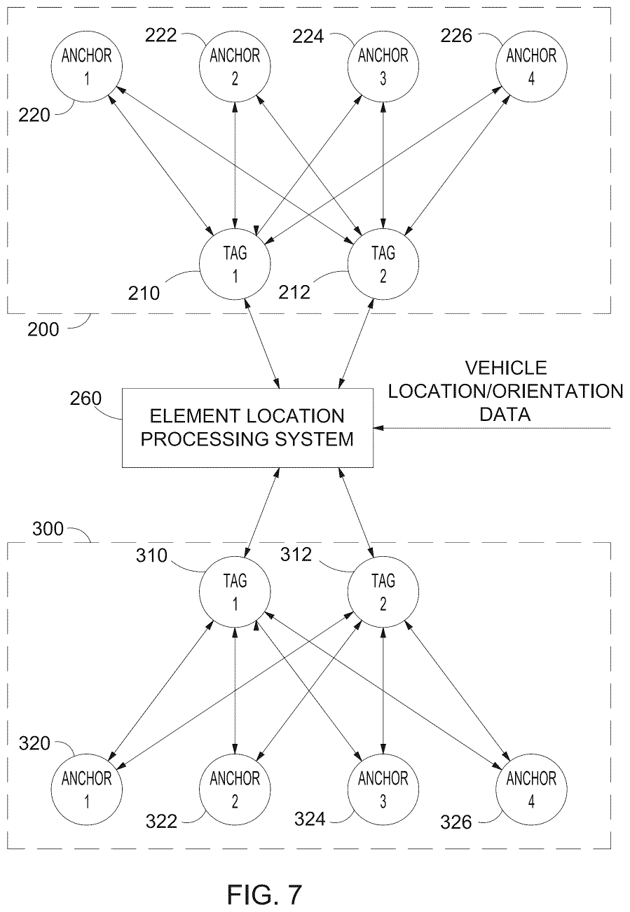

As further illustrated in FIGS. 1 and 2, the loader 100 includes a first system 200 (see FIGS. 6 and 7) of tags and anchors, which are positioned at respective locations on the front body section 112 of the loader. For example, the first system of tags and anchors includes a first tag 210 positioned at a known location on the boom arm 144. The first system of tags and anchors includes a second tag 212 positioned at a known location on the work implement 140. The first system of tags and anchors includes a first anchor 220 positioned at a first known location on the front body section of the loader, a second anchor 222 positioned at a second known location on the front body section of the loader, a third anchor 224 positioned at a third known location on the front body section of the loader, and a fourth anchor 226 positioned at a fourth known location on the front body section of the loader. The fourth anchor is illustrated in dashed lines to indicate that the fourth anchor is behind the left front wheel 116. Although the positions of the tags in three dimensions can be determined mathematically by using only three anchors, only four anchors are used in the illustrated embodiment to simplify the mathematics and thereby reduce the calculation time. More anchors can be used; however, only the four-anchor implementation is described below.

In the illustrated embodiments, the two tags 210, 212 and the four anchors 220, 222, 224. 226 are based on ultra-wideband (UWB) location identification technology similar to the technology used in the Apple® AirTag® item finders. In the following description, each tag can be a conventional Apple AirTag or an equivalent. Each anchor includes the UWB signal transmission and reception technology and further includes an associated processing system to initiate transmission of signals and to process received signals. For example, in one embodiment disclosed herein, the UWB technology and the processing system are combined in a DW3000 UWB Transceiver, which is commercially available from Qorvo, Inc, of Greensboro, North Carolina. In other embodiments, each tag can also be a DW3000 UWB transceiver or an equivalent. As described below, the tags operate as polling devices, and the anchors operate as responding devices.

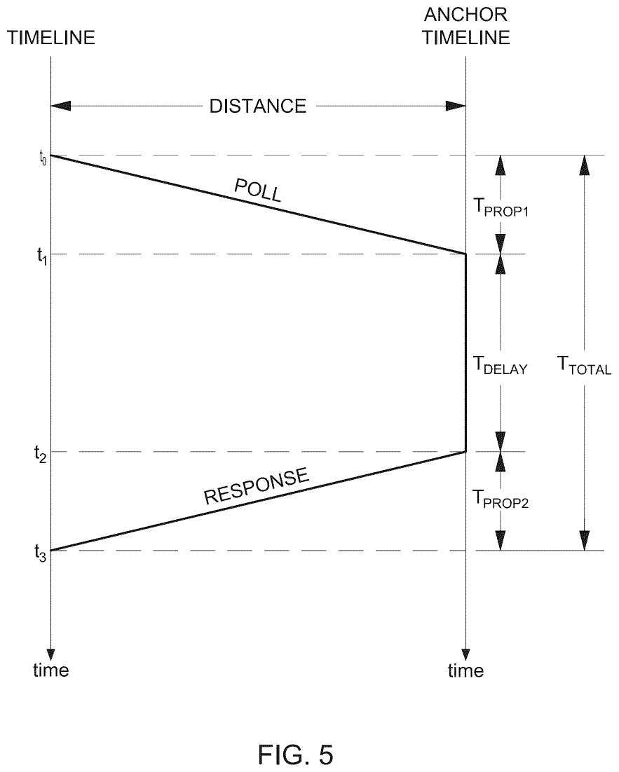

To determine the location of the first tag 210, the first tag sends out a respective first polling signal that includes a system number and a first unique identification number to the first anchor 220 to initiate a respective first distance measurement. As illustrated by a tag timeline in FIG. 5, the polling signal is sent at a time t₀. The first anchor receives the polling signal at a time t₁ after a first propagation time T_{PROP1} (e.g., t₁=t₀+T_{PROP1}). The first propagation time is determined by an unknown first distance d₁ between the first tag and the first anchor and by the known propagation velocity of the UWB signal. After a known first internal delay T_{DELAY}, the first anchor sends out a first response signal at a time t₂ (e.g., t₂=t₁+T_{DELAY}). The first tag receives the first response signal at a time t₃ after a second propagation time T_{PROP2} (e.g., t₃=t₂+T_{PROP2}). The second propagation time should be substantially the same as the first propagation time because the unknown first distance d₁ is unlikely to change by a measurable quantity in the short time between the initial polling time t₀ and the receiving time t₃. Thus, the first tag receives the response signal a first total time duration T_{TOTAL} after sending the first polling signal. The first total time duration T_{TOTAL} is determined by comparing the internal clock value t₃ when the response signal is received to the internal clock value to when the polling signal was sent. The first total time duration is the sum of the first propagation time, the first internal delay, and the second propagation time. Since the first internal delay is known (as described below) and since the first and second propagation times are the same or substantially the same, the first propagation time can be determined by subtracting the first internal delay from the first total time duration and by dividing the subtraction result by two:

$${T}_{P R O P 1} = \frac{( {t}_{3} - {t}_{0} ) - {T}_{D E L A Y}}{2}$$

The first distance d₁ is determined by multiplying the first propagation time T_{PROP1} by the known UWB signal propagation velocity. The calculation of the first distance d₁ may be determined by the first tag. Alternatively, the first propagation time can be sent to the first anchor, which calculates the first distance d₁.

The internal delay time within each anchor can vary because of manufacturing tolerances; however, the delay time within each anchor can be adjusted as part of the configuration process to a common, known delay time by using a known distance between two devices and measuring the overall send/receive delay. The delay time of the anchors can be programmed into the first tag 210 as part of a configuration process. The first tag uses the respective delay time of each anchor 220, 222, 224, 224 to compute the propagation time as described above.

After determining the first distance d₁, the first tag 210 sends out a respective second polling signal that includes the system number and a second unique identification number to the second anchor 222 to initiate a respective second distance measurement. The first tag receives a second response signal from the second anchor after a measurable second total time duration. The first tag then determines a propagation time to the second anchor by subtracting a second internal delay of the second anchor from the second total time duration and by dividing the subtraction result by two as discussed above. A second distance d₂ is determined by multiplying the second propagation time by the known UWB signal propagation velocity. The calculation of the second distance d₂ may be determined by the first tag. The second propagation time can also be sent to the second anchor, which calculates the second distance d₂.

In like manner, the first tag 210 sends respective polling signals and receives respective response signals from the third anchor 224 and the fourth anchor 226 and determines a third distance d₃ and a fourth distance d₄, respectively.

The first distance d₁, the second distance d₂, the third distance d₃, and the fourth distance d₄ are used to calculate the x, y. z coordinates of the first tag 210. The calculations can be performed by the first tag, by one of the four anchors 220, 222, 224, 226, or by a location processing system discussed below.

FIG. 6 illustrates a schematic representation of the first tag 210 and the first anchor 220, the second anchor 222, the third anchor 224, and the fourth anchor 226 in a three-dimensional (x, y, z) coordinate system, which is defined with respect to the rear body section 114 of the loader 100. The coordinate system can be defined in multiple ways; however, for the purpose of the following discussion, the x and y coordinates are considered to be in plane generally parallel to the terrain on which the loader is positioned. The x-axis runs the length of the loader from front to rear. The y-axis traverses the loader from left to right. The z-axis is oriented perpendicular to the plane of the x-axis and the y-axis and extends upward.

In FIG. 6, the first anchor 220 is located at a first vertex A of a four-sided shape. The first vertex A is defined by x, y, z coordinates x_{A}, y_{A}, z_{A}. The second anchor 222 is located at a second vertex B of the shape. The second vertex B is defined by x, y, z coordinates x_{B}, y_{B}, z_{B}. The third anchor 224 is located a third vertex C of the shape. The third vertex C is defined by x, y, z coordinates x_{C}, y_{C}, z_{C}. The fourth anchor 226 is located at a fourth vertex D of the shape. The fourth vertex D is defined by x, y, z coordinates x_{D}, y_{D}, z_{D}. Although the four vertices of the shape might appear to be in a common plane in FIG. 6, the method disclosed herein does not require the four anchors and the corresponding vertices to be in a common plane.

The respective x, y, z coordinates of each vertex A, B, C, D in FIG. 6 are fixed and are known as part of the installation of the four anchors 220, 222, 224, 226 on the loader 100. Accordingly, the distances between the four vertices in each of the x, y, z coordinate directions are also fixed and known by simple calculations. The known coordinates of the four anchors are programmed into the first tag as part of the configuration process. Alternatively, the coordinates of each anchor may be transmitted from the anchor to the tag as part of the response to the polling signal. In alternative embodiments where one or more of the anchors or a processing system (discussed below) perform the calculations, the fixed coordinates are provided to the element performing the calculations.

The first tag 210 is located at a fifth vertex E. The fifth vertex E is defined by x, y, z coordinates x_{E}, y_{E}, z_{E}. The fifth vertex E is connected to the first vertex A by a line having a first variable length (distance) L_{AE}, which corresponds to the first distance d₁ determined by the first tag by sending a polling signal to and by receiving a polling signal from the first anchor 220 as described above. The fifth vertex E is connected to the second vertex B by a line having a second variable length (distance) L_{BE}, which corresponds to the second distance d₂ determined by the first tag by sending a polling signal to and by receiving a polling signal from the second anchor 222 as described above. The fifth vertex E is connected to the third vertex C by a line having a third variable length (distance) L_{CE}, which corresponds to the third distance d₃ determined the first tag by sending a polling signal to and by receiving a polling signal from the third anchor 224 as described above. The fifth vertex E is connected to the fourth vertex D by a line having a fourth variable length (distance) L_{DE}, which corresponds to the fourth distance d₄ determined by the first tag by sending a polling signal to and by receiving a polling signal from the fourth anchor 226 as described above.

In the illustrated embodiment, the first tag 210 selects the fourth anchor 226 at the fourth vertex D as a reference anchor. The method establishes the following constants based on the fixed, known locations of the vertices A, B, and C with respect to the fourth vertex D:

$${x}_{A} - {x}_{D} = x distance from the first vertex A to the fourth vertex D$$

$${y}_{A} - {y}_{D} = y distance from the first vertex A to the fourth vertex D$$

$${z}_{A} - {z}_{D} = z distance from the first vertex A to the fourth vertex D$$

$${x}_{B} - {x}_{D} = x distance from the second vertex B to the fourth vertex D$$

$${y}_{B} - {y}_{D} = y distance from the second vertex B to the fourth vertex D$$

$${z}_{B} - {z}_{D} = z distance from the second vertex B to the fourth vertex D$$

$${x}_{C} - {x}_{D} = x distance from third vertex C to the fourth vertex D$$

$${y}_{C} - {y}_{D} = y distance from third vertex C to the fourth vertex D$$

$${z}_{C} - {z}_{D} = z distance from third vertex C to the fourth vertex D$$

The method also establishes the following constants based on the fixed known coordinates of the four vertices:

$${k}_{A} = {x}_{A}^{2} + {y}_{A}^{2} + {z}_{A}^{2}$$

$${k}_{B} = {x}_{B}^{2} + {y}_{B}^{2} + {z}_{B}^{2}$$

$${k}_{C} = {x}_{C}^{2} + {y}_{C}^{2} + {z}_{C}^{2}$$

$${k}_{D} = {x}_{D}^{2} + {y}_{D}^{2} + {z}_{D}^{2}$$

As described, for example, in Mathias Pelka, “Position Calculation with Least Squares based on Distance Measurements,” Lubeck University of Applied Sciences: Technical Support 2015, the foregoing measurements can be solved for the unknown variable coordinates x_{E}, y_{E}, z_{E} of the first tag 210 by using the following three equations with the three unknown coordinate values x_{E}, y_{E}, z_{E} on the left sides of the equations and with the known values (k_{A}, k_{B}, k_{C}, k_{D}) and the measured values (L_{AE}², L_{BE}², L_{CE}², L_{DE}²) on the right sides of the equations:

$$( {x}_{A} - {x}_{D} ) {x}_{E} + ( {y}_{A} - {y}_{D} ) {y}_{E} + ( {z}_{A} - {z}_{D} ) {z}_{E} = ( {L}_{DE}^{2} - {L}_{AE}^{2} + {k}_{A} - {k}_{D} ) / 2$$

$$( {x}_{B} - {x}_{D} ) {x}_{E} + ( {y}_{B} - {y}_{D} ) {y}_{E} + ( {z}_{B} - {z}_{D} ) {z}_{E} = ( {L}_{DE}^{2} - {L}_{BE}^{2} + {k}_{B} - {k}_{D} ) / 2$$

$$( {x}_{C} - {x}_{D} ) {x}_{E} + ( {y}_{C} - {y}_{D} ) {y}_{E} + ( {z}_{C} - {z}_{D} ) {z}_{E} = ( {L}_{DE}^{2} - {L}_{CE}^{2} + {k}_{C} - {k}_{D} ) / 2$$

The three foregoing equations can be solved using linear algebra using the following 3×3 A matrix and the following 3×1 b matrix:

$$A = \vert \begin{matrix}{x}_{A} - {x}_{D} & {y}_{A} - {y}_{D} & {z}_{A} - {z}_{D} \\ {x}_{B} - {x}_{D} & {y}_{B} - {y}_{D} & {z}_{B} - {z}_{D} \\ {x}_{C} - {x}_{D} & {y}_{C} - {y}_{D} & {z}_{C} - {z}_{D}\end{matrix} \vert$$

$$b = \vert \begin{matrix}\frac{{L}_{DE}^{2} - {L}_{AE}^{2} + {k}_{A} - {k}_{D}}{2} \\ \frac{{L}_{DE}^{2} - {L}_{BE}^{2} + {k}_{B} - {k}_{D}}{2} \\ \frac{{L}_{DE}^{2} - {L}_{CE}^{2} + {k}_{C} - {k}_{D}}{2}\end{matrix} \vert$$

The inverse (A⁻¹) of the A matrix is multiplied by the b matrix to obtain the following result R matrix:

$$R = {A}^{- 1} b = \vert \begin{matrix}{x}_{E} \\ {y}_{E} \\ {z}_{E}\end{matrix} \vert$$

The matrix algebra described above reaches a precise solution when the distance measurements to the four anchors 220, 222, 224, 226 are precise. If the measurements are not precise, a known “least squares” method can be performed to obtain a solution that minimizes the errors in the calculations. Other processes may be used to determine the coordinates of the tag based on the measured distances and the known coordinates of the anchors.

Knowing the location of the first tag 210 on the boom arm 144 in the x, y coordinate system enables a location processing system 260 (FIG. 7) to determine the angle of the boom arm with respect to the front body section 112. Because the second tag is at a known radial distance from the first pivot axis A1, which is at a known location on the loader 100, a calculated radial distance of the second tag from the first pivot axis A1 based on the coordinates determined by the second tag can be compared to the known radial distance and the coordinates can be adjusted as needed such that the calculated coordinates lie on an arc centered on the first pivot axis A1.

The foregoing method can also be used by the second tag 212 to determine the respective x, y, and z coordinates of the second tag located on the work implement 140. The second tag can communicate with the first anchor 220, the second anchor 222, the third anchor 224, and the fourth anchor 226, in the first set 200 of tags and anchors. Alternatively, the second tag can be in a different set (not shown) of tags and anchors and can communicate with a four (or more) anchors (not shown) in the different set of tags and anchors. The different set of tags and anchors can comprise four different anchors or may comprise one or more of the anchors in the first set of tags and anchors and one or more different anchors (not shown).

The second tag 212 is at a known location on the work implement 140 with respect to the second pivot axis A2. The engagement edge 142 of the work implement is also at a known location with the second pivot axis A2. The location of the first tag 210 with respect to the front body section 112 of the loader 100 is determined as described above. The location of the second pivot axis A2 with respect to the first tag is known. Thus, vector mathematics can be used to calculate the position of the engagement edge of the work implement with respect to the front body section of the loader.

After the first tag 210 and the second tag 212 determine the respective coordinates of the two tags, the two tags send the coordinates to the location processing system 260 (FIG. 7), which combines the locations of the tags in the three-dimensional coordinate system of the loader 100 with the location and orientation of the loader in an overall coordinate system as discussed above. As further discussed above, the calculations of the locations of the two tags in the coordinate system of the loader can be performed by the tags, by the anchor, by the location processing system, or by a combination of any two or more of the tags, the anchors, and the location processing system.

As illustrated in FIGS. 3 and 4, the front body section 112 of the loader 100 includes a second system 300 (see FIG. 7) of tags and anchors positioned generally in known locations on upper surfaces of the loader. As described below, the second system of tags and anchors is used to determine the orientation of the front body section with respect to the rear body section. A first tag 310 and a second tag 312 are located on an upper surface of the front body section and are disposed across from each other in the direction of the y-axis. In the illustrated embodiment, a first anchor 320, a second anchor 322, a third anchor 324, and a fourth anchor 326 are located on respective corners on the roof of the operator cab 130 of the rear body section 114. Again, the four anchors do not have to be located in a common plane. Although one tag is sufficient to determine the position and orientation of the front body section with respect to the rear body section, using two or more tags to make corresponding measurements enables the location processing system 260 to compensate for potential measurement errors. For example, if an angle is calculated based on the coordinates of the two tags result in two different values, the angles can be averaged.

As discussed above, matrix algebra can be used to calculate the coordinates of the two tags 310, 312 in the second system of tags and anchors 300. As discussed above, If precise solutions for the coordinates are not found, a known “least squares” method can be performed to obtain a solution that minimizes the errors in the calculations.

The location and orientation of the loader 100 can be determined in a known manner by using a global positioning system (GPS) device or other conventional system. For example, the position and orientation of the loader may be located with respect to known markers at a job site, and the locations of the tags with respect to the loader can be vectorially added to the position and orientation of the loader to determine the locations of the tags with respect to the job site and thereby determine the location and orientation of the front body section. Since the locations of the boom arm 144, the work implement 140, and the engagement edge 142 of the work implement can be determined as described above, the location of the engagement edge can be readily determined by applying vector mathematics. The position of the engagement edge determines how the terrain is modified, and the present system and method enhance the control of the positioning of the engagement edge.

The foregoing discussion is based on the tags and the anchors being positioned in independent planes such that the locations of the tags and the anchors are defined by respective pairs of x, y, z coordinates. If, for example, the tags and anchors in an embodiment are positioned in a common plane, then the locations can be defined by pairs of coordinates (e.g., x, y or x, z) such that only two equations are needed to solve the locations of the tags.

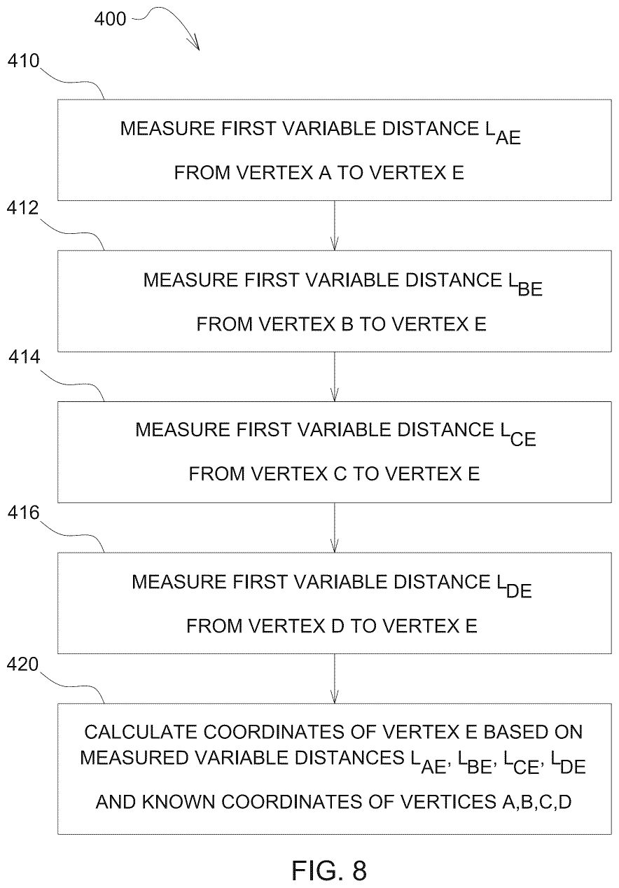

The method of locating the first tag 210 described above is summarized in a flowchart 400 in FIG. 8. In a first action block 410, the first tag measures the first variable distance L_{AE} from the first vertex A (representing the first anchor 220) to the fifth vertex E (representing the first tag). In a second action block 412, the first tag measures the second variable distance L_{BE} from the second vertex B (representing the second anchor 222) to the fifth vertex E. In a third action block 414, the first tag measures the third variable distance L_{CE} from the third vertex C (representing the third anchor 224) to the fifth vertex E. In a fourth action block 416, the first tag measures the fourth variable distance L_{DE} from the fourth vertex D (representing the fourth anchor 226) to the fifth vertex E. In a fifth action block 420, the first tag combines uses the four measured variable distances and the known coordinates of the first, second, third and fourth anchors to calculate the coordinates of the first tag as described above.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A method of determining a coordinate position of a movable device, which moves with respect to a work vehicle coordinate system of a work vehicle, the method comprising:
determining a first variable distance of the movable device from a first fixed device positioned at a first fixed set of coordinates in the work vehicle coordinate system by sending a first polling signal from the movable device to the first fixed device, receiving a first response signal from the first fixed device, and determining a first propagation time between sending the first polling signal and receiving the first response signal:
determining a second variable distance of the movable device from a second fixed device positioned at a second fixed set of coordinates in the work vehicle coordinate system by sending a second polling signal from the movable device to the second fixed device, receiving a second response signal from the second fixed device, and determining a second propagation time between sending the second polling signal and receiving the second response signal:
determining a third variable distance of the movable device from a third fixed device positioned at a third fixed set of coordinates in the work vehicle coordinate system by sending a third polling signal from the movable device to the third fixed device, receiving a third response signal from the third fixed device, and determining a third propagation time between sending the third polling signal and receiving the third response signal:
determining a fourth variable distance of the movable device from a fourth fixed device positioned at a fourth fixed set of coordinates in the work vehicle coordinate system by sending a fourth polling signal from the movable device to the fourth fixed device, receiving a fourth response signal from the fourth fixed device, and determining a fourth propagation time between sending the fourth polling signal and receiving the fourth response signal:
and
calculating a coordinate position of the movable device in the work vehicle coordinate system based on the first, second, third, and fourth sets of coordinates and the first, second, third, and fourth variable distances.

2. The method of claim 1 wherein:
determining each of the first, second, third, and fourth propagation times comprises:
measuring a respective time duration from sending the respective polling signal from the movable device to the respective fixed device to receiving the respective response signal from the respective fixed device;
subtracting a respective known delay time within the respective fixed device from the respective time duration to obtain a respective two-way propagation time; and
dividing the respective two-way propagation time by two to generate the respective propagation time.

3. The method of claim 2 wherein the respective delay times of the respective fixed devices are substantially equal.

4. The method of claim 1 wherein the first, second, third, and fourth polling signals and the first, second, third, and fourth response signals are ultra-wideband (UWB) signals operating in a range of 3.1 GHz to 10.6 GHz.

5. The method of claim 1 further comprising sending the calculated coordinate location of the movable device to a processing system, the processing system combining the coordinate location of the movable device with a coordinate location of the work vehicle in a primary coordinate system to produce a coordinate location of the movable device in the primary coordinate system.

6. The method of claim 1 wherein:
the work machine is a loader;
the movable device is a first movable device positioned on the boom arm of the loader; and
the fixed devices are positioned on a body section of the loader.

7. The method of claim 6 further including a second movable device positioned on a work implement pivotally attached to the boom arm of the loader, the second movable device determining respective first, second, third, and fourth variable distances to the respective first, second, third, and fourth fixed devices and calculating a position of the second movable device in the work vehicle coordinate system.

8. The method of claim 1 wherein:
the work machine is an articulated loader having a rear body section and an articulated front body section, which pivots with respect to the rear body section;
the movable device is positioned on the front body section of the articulated loader;
the fixed devices are positioned on the rear body section of the articulated loader; and
the movable device calculates a position of the movable device in a coordinate system of the rear body section.

9. The method of claim 8 wherein the position of the movable device in the coordinate system of the rear body section is used to calculate an articulation angle of the front body section with respect to the rear body section.

10. A method of determining a location of a movable element of a work vehicle with respect to a worksite coordinate system comprising:
determining a location and orientation of the work vehicle with respect to the worksite coordinate system;
positioning first, second, and third communication devices at respective first, second, and third known locations in a work vehicle coordinate system;
positioning a fourth communication device on the movable element of the work vehicle, the fourth communication device positioned at an unknown variable location in the work vehicle coordinate system;
sending respective first, second, and third polling signals from the fourth communication device to the first, second, and third communication devices;
receiving respective first, second, and third response signals by the fourth communication device from the respective first, second, and third communication devices;
determining respective first, second, and third variable distances from the fourth communication device to the respective first, second, and third communication devices based on respective calculated propagation times between the fourth communication device and the respective first, second, and third communication devices;
calculating a location of the fourth communication device in the work vehicle coordinate system based on the first, second, and third known locations, respectively, of the first, second, and third communication devices, and the first, second, and third variable distances; and
combining the location of the fourth communication device in the work vehicle coordinate system with the location and orientation of the work vehicle in the worksite coordinate system to determine the location of the fourth communication device in the worksite coordinate system.

11. A work vehicle comprising:
a front body section and a rear body section, the rear body section housing a power generation system, the front and rear body sections supporting ground engagement units that move the work vehicle with respect to the terrain of a worksite in response to power provided by the power generation system;
at least one working element movably coupled to a portion of the work vehicle;
at least first, second, third, and fourth communication devices, positioned at respective first, second, third, and fourth known locations in a work vehicle coordinate system;
at least a fifth communication device positioned on the at least one working element, the fifth communication device configured to:
poll the first, second, third, and fourth communication devices; receive a respective response from each of the first, second, third, and fourth communication devices; and determine a respective first, second, third, and fourth variable distance from the fifth communication device to each of the respective first, second, third, and fourth communication devices;
calculate a variable location of the fifth communication device in the work vehicle coordinate system based on the first, second, third, and fourth known locations and the first, second, third, and fourth variable distances; and
outputting data representing the variable location of the fifth communication device in the work vehicle coordinate system;
and
at least one vehicle positioning system configured to determine a location and orientation of the work vehicle in a worksite coordinate system, the vehicle positioning system further configured to receive the data representing the variable location of the fifth communication device and to determine the location of the working element in the worksite coordinate system.

12. The work vehicle of claim 11 wherein:
the working element is a boom arm pivotally coupled to the front body section of the work vehicle; and
the fifth communication device is located on the boom arm.

13. The work vehicle of claim 11 wherein:
the working element is a work implement pivotally coupled to a boom arm of the work vehicle; and
the fifth communication device is located on the work implement.

14. The work vehicle of claim 11 wherein:
the working element is the front body section of the work vehicle, which is articulately coupled to the rear body section of the work vehicle;
the fifth communication device is located on the front body section; and
the first, second, third, and fourth communication devices are located on the rear body section of the work vehicle.
